(19) United States
(12) Patent Application Publication
(10) Pub. No.: US 2024/0331679 A1
(43) Pub. Date: Oct. 3, 2024

(54) MACHINE LEARNING-BASED FEEDBACK CANCELLATION

(71) Applicant: QUALCOMM Incorporated, San Diego, CA (US)

(72) Inventors: Vahid Montazeri, Newport Beach, CA (US); Rogerio Guedes Alves, Macomb Township, MI (US); You Wang, San Diego, CA (US); Jacob Jon Bean, Vista, CA (US); Erik Visser, San Diego, CA (US)

(21) Appl. No.: 18/611,494

(22) Filed: Mar. 20, 2024

Related U.S. Application Data
(60) Provisional application No. 63/611,639, filed on Dec. 18, 2023.
(60) Provisional application No. 63/493,158, filed on Mar. 30, 2023.

(51) Int. Cl. G10K 11/178

(52) U.S. Cl. CPC G10K 11/17825; G10K 11/17875; G10K 2210/3026; G10K 2210/3028; G10K 2210/3038; G10K 2210/506

(57) ABSTRACT

This disclosure provides systems, methods, and devices for audio signal processing that support feedback cancellation in a personal audio amplification system. In a first aspect, a method of signal processing includes receiving an input audio signal, wherein the input audio signal includes a desired audio component and a feedback component; and reducing the feedback component by applying a machine learning model to the input audio signal to determine an output audio signal. Other aspects and features are also claimed and described.

### CROSS-REFERENCE TO RELATED APPLICATIONS

This application claims the benefit of U.S. Provisional Patent Application No. 63/611,639, entitled “MACHINE LEARNING-BASED FEEDBACK CANCELLATION,” filed on Dec. 18, 2023, and claims the benefit of U.S. Provisional Patent Application No. 63/493,158, entitled “LOW-LATENCY NOISE SUPPRESSION,” filed on Mar. 30, 2023, which are both expressly incorporated by reference herein in their entirety.

### TECHNICAL FIELD

Aspects of the present disclosure relate generally to audio signal processing, and more particularly, to amplification systems with reduced artifacts. Some features may enable and provide improved audio signal processing, including improved audio quality by reducing howling sounds resulting from feedback when amplifying audio signals.

### INTRODUCTION

Audio playback devices are devices that can reproduce one or more audio signals, whether digital or analog signals. Audio playback can be incorporated into a wide variety of devices. By way of example, audio playback devices may comprise stand-alone audio devices, mobile telephones, cellular or satellite radio telephones, personal digital assistants (PDAs), panels or tablets, gaming devices, or computing devices.

One class of audio playback devices are wearable devices (e.g., ear buds, headphones, hearing aids, etc.), which can be used to improve hearing, situational awareness, and/or intelligibility of speech. Generally, such devices apply relatively simple noise suppression processes to remove as much of the ambient noise as possible. The noise suppression operations may introduce artifacts to reproduced sounds, artifacts that reduce a signal-to-noise ratio (SNR) (of the speech relative to ambient noise). This may be a problem because the desired sound, such as speech, may be obscured by the introduced artifacts. For some individuals, speech is readily intelligible only when the signal-to-noise ratio (of the speech relative to ambient noise) is above a certain level, resulting in the artifacts making speech unrecognizable.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, audio amplification devices may use machine learning (ML)-based adaptive feedback cancellation to remove artifacts, such as howling, caused by feedback between a speaker and a microphone. In some embodiments, an ML model may be trained to preserve speech components and other desirable sound components (such as environment sounds) while removing undesirable components, such as feedback or howling components. That is, an audio signal may include multiple components from the environment such as bird sounds, car noise, human speech, and feedback from a speaker. Some components may be desirable to be heard (e.g., bird sounds and human speech). Other components may be undesirable to be heard (e.g., car noise and feedback). The ML-model may be trained to recognize the sounds in an audio signal and remove those components of the audio signal that are undesirable.

The ML-based feedback cancellation offers improved performance over conventional adaptive filters in traditional feedback cancellation circuitry. For example, the ML-based feedback cancellation may be more effective in isolating the feedback component of an audio signal and/or may preserve more of the desirable sound components when removing the feedback component. The effectiveness is increased, in some embodiments, because the ML-based feedback cancellation can compensate for linear and nonlinear components related to feedback by modeling nonlinearities of an amplifier circuit. Although the ML-based model may be used in audio amplification systems in a similar manner as an adaptive filter, the ML-based model may solve other problems in feedback cancellation and offer additional functionality and advantages in feedback cancellation, which are described in additional detail in the detailed description of some embodiments that follow.

In one aspect of the disclosure, a method for signal processing includes receiving an input audio signal, wherein the input audio signal includes a desired audio component and a feedback component; and reducing the feedback component by applying a machine learning model to the input audio signal to determine an output audio signal. The machine learning model may be trained to generate feedback cancellation signals that, when combined with the input audio signal, reduce a magnitude or audible perception of feedback components. Such a machine learning model may be trained using training data that includes sample microphone signals recorded in the presence of feedback from a loudspeaker, in which each set of the training data includes a sample microphone signal and a representation of the feedback component present in the sample microphone signal and/or a representation of a desired feedback cancellation signal for the sample microphone signal. The ML model may be trained by loading pre-computed weights or other parameters of the ML model at startup of the ML model. The ML model may alternatively be trained by providing training data and configuring the ML model based on the known feedback cancellation signals of the training data.

In an additional aspect of the disclosure, an apparatus includes at least one processor and a memory coupled to the at least one processor. The at least one processor is configured to perform operations including receiving an input audio signal, wherein the input audio signal includes a desired audio component and a feedback component; and reducing the feedback component by applying a machine learning model to the input audio signal to determine an output audio signal.

In an additional aspect of the disclosure, an apparatus includes means for receiving an input audio signal, wherein the input audio signal includes a desired audio component and a feedback component; and means for reducing the feedback component by applying a machine learning model to the input audio signal to determine an output audio signal.

In an additional aspect of the disclosure, a non-transitory computer-readable medium stores instructions that, when executed by at least one processor, cause the processor to perform operations. The operations include receiving an input audio signal, wherein the input audio signal includes a desired audio component and a feedback component; and reducing the feedback component by applying a machine learning model to the input audio signal to determine an output audio signal.

Methods of audio signal processing described herein may be performed by a signal processing device. The audio signal processing may be applied to audio data captured by one or more microphones of the signal processing device. Audio signal processing devices, devices that can playback, record, and/or process one or more audio recordings can be incorporated into a wide variety of devices. By way of example, audio signal processing devices may comprise stand-alone audio devices, such as entertainment devices and personal media players, wireless communication device handsets such as mobile telephones, cellular or satellite radio telephones, personal digital assistants (PDAs), tablets, gaming devices, computing devices such as webcams, video surveillance cameras, or other devices with audio recording or audio capabilities.

The audio signal processing techniques described herein may involve devices having microphones and processing circuitry (e.g., application specific integrated circuits (ASICs), digital signal processors (DSPs), graphics processing units (GPUs), or central processing units (CPUs)).

In some aspects, a device may include a digital signal processor or a processor (e.g., an application processor) including specific functionality for audio processing. The methods and techniques described herein may be entirely performed by the digital signal processor or the processor, or various operations may be split between the digital signal processor and the processor, and in some aspects split across additional processors. In some embodiments, the methods and techniques disclosed herein may be adapted using input from a neural signal processor (NSP) in which one or more parameters of the signal processing are controlled based on output from a machine learning (ML) model executed by the NSP.

In an additional aspect of the disclosure, a device configured for audio signal processing and/or audio capture is disclosed. The apparatus includes means for recording audio. Example means may include a dynamic microphone, a condenser microphone, a ribbon microphone, a carbon microphone, or a crystal microphone. The microphone may be construed as a microelectromechanical system (MEMS). These components may be controlled to capture first and/or second sound recordings, which may correspond to left and right channels of a recording.

For any of these types of microphones, the microphones may include analog and/or digital microphones. Analog microphones provide a sensor signal, which is some embodiments is conditioned or filtered. Analog microphones in a digital system include an external analog-to-digital converter (ADC) to interface with digital circuitry. Digital microphones include the ADC and other digital elements to convert the sensor signal into a digital data stream, such as a pulse-density modulated (PDM) stream or a pulse-code modulated (PCM) stream.

Aspects disclosed herein describe use of machine learning models as solutions to problems with amplification artifacts such as howling. Although embodiments of the disclosure described herein illustrate the use of a single machine learning model, embodiments may employ multiple machine learning models to perform the operations described herein. For example, independent machine-learning models may be configured to analyze and process respective frequency subbands of audio data, enabling appropriate processing by subband. Each of the independent machine-learning models is trained and optimized to process a respective subband. As one example, a low-frequency subband of an audio segment can correspond to speech while a high-frequency subband of the same audio segment corresponds to noise. A first machine-learning model processes low-frequency subband audio data to generate first enhanced subband audio data in which speech is retained or enhanced. A second machine-learning model processes high-frequency subband audio data to generate second enhanced subband audio data in which noise is reduced. A combiner is used to combine the first enhanced subband audio data and the second enhanced subband audio data to generate enhanced audio data. As another example, the first machine-learning model is trained to retain speech in low-frequency subband audio and the second machine-learning model is trained to reduce noise in the high-frequency subband audio, which may benefit from having lower complexity and higher efficiency than a single machine-learning model that is trained to process a larger frequency band to reduce speech in the low-frequency subband audio and reduce noise in the high-frequency subband audio.

A problem of a machine-learning model for processing the larger frequency band is that the machine-learning model is better suited for processing some subbands than others. For example, a long short-term memory network (LSTM) based masking network can be better suited for processing low-frequency subband audio, whereas a convolutional neural network can be better suited for processing high-frequency subband audio. Independent machine-learning models can solve this problem by having different model architectures that are better suited to processing the respective subbands. In an example, the first machine-learning model that is trained to process low-frequency subband audio can include a LSTM-based masking network and the second machine-learning model that is trained to process high-frequency subband audio can include a convolutional neural network (e.g., U-Net) architecture. In some examples, procedural signal processing can be performed for audio enhancement of a particular subband, audio enhancement can be bypassed for another subband, or both.

A single large complex machine-learning model can have high resource usage (e.g., computing cycles, memory, etc.) that can limit the types of devices that can support the machine-learning model. This problem can be solved by independent machine-learning models that do not have to be co-located. For example, processing of the low-frequency subband audio can be performed at a first device that includes the first machine-learning model and processing of the high-frequency subband audio can be performed at a second device that includes the second machine-learning model. At least some of the subband audio processing can thus be offloaded to another device.

Reconfiguring a large machine-learning model can change processing for the entire frequency band. The independent machine-learning models can solve this problem by being independently configurable. For example, an updated configuration that is better suited for the low-frequency subband audio can be used for the first machine-learning model without changing the second machine-learning model. In another example, the second machine-learning model can be updated to have a second configuration that is better suited to the high-frequency subband audio. The configuration of the independent machine-learning models can be obtained from one or more sources, e.g., other devices, based on context of the audio.

In some cases, different microphones may capture audio that has better audio quality in different subbands. For example, a first microphone is nearer a first sound source (e.g., a speech source), and a second microphone is nearer a second sound source (e.g., a music source). In this example, first low-frequency subband audio data from the first microphone is selected for processing using a first machine-learning model to generate first enhanced subband audio data in which speech is retained or enhanced, and second high-frequency subband audio data from the second microphone is selected for processing using a second machine-learning model to generate second enhanced subband audio data in which music is retained or enhanced.

In some examples, a machine-learning model is used to process subband audio data from multiple microphones to generate enhanced subband audio data. A first machine-learning model is used to process first low-frequency subband audio data from a first microphone and second low-frequency subband audio data from a second microphone to generate enhanced low-frequency subband audio data. A second machine-learning model is used to process first high-frequency subband audio data from the first microphone and second high-frequency subband audio data from the second microphone to generate enhanced high-frequency subband audio data.

Processing audio data from multiple microphones can improve performance of machine-learning models. For example, the enhanced low-frequency subband audio data generated by the first machine-learning model that processes low-frequency subband audio data from multiple microphones can have enhanced speech and reduced noise as compared to enhanced low-frequency subband audio data based on low-frequency subband audio data from a single microphone. As another example, the enhanced high-frequency subband audio data generated by the second machine-learning model that processes high-frequency subband audio data from multiple microphones can have enhanced speech and reduced noise as compared to enhanced high-frequency subband audio data based on high-frequency subband audio data from a single microphone.

Separate machine-learning models that are trained to process different subbands can have lower complexity (e.g., fewer network nodes, network layers, etc.) and higher efficiency (e.g., faster processing time, fewer computing cycles, etc.) as compared to a single machine-learning model that is trained to process a larger frequency band that includes the subbands.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos (with associated or embedded sounds) in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of a system-on-chip (SoC) configured for performing signal processing according to one or more aspects of this disclosure.

FIG. 2 is a block diagram illustrating an example data flow path for audio signal processing in a multimedia device according to one or more aspects of the disclosure.

FIG. 3 is a block diagram illustrating an audio system with machine learning-based feedback cancellation according to some embodiments of the disclosure.

FIG. 4 is a block diagram illustrating an audio system with machine learning-based feedback cancellation application before forward path processing according to some embodiments of the disclosure.

FIG. 5 is a block diagram illustrating an audio system with machine learning-based feedback cancellation and other feedback cancellation according to some embodiments of the disclosure.

FIG. 6 is a block diagram illustrating an audio system with machine learning-based feedback cancellation based on additional sensors according to some embodiments of the disclosure.

FIG. 7 is a block diagram illustrating an audio system with machine learning-based feedback cancellation applied through a time-domain filter according to some embodiments of the disclosure.

FIG. 8 shows a flow chart of an example method for processing audio data to perform acoustic source separation according to some embodiments of the disclosure.

FIG. 9 is an illustrative block diagram of an example machine learning (ML) model represented by an artificial neural network (ANN) according to some embodiments of the disclosure.

FIG. 10 is a diagram of a headset operable to perform feedback cancellation in accordance with some examples of the present disclosure.

FIG. 11 is a diagram of a headset, such as a virtual reality, mixed reality, or augmented reality headset, operable to perform feedback cancellation in accordance with some examples of the present disclosure.

FIG. 12 is a diagram of augmented reality glasses operable to perform feedback cancellation in accordance with some examples of the present disclosure.

FIG. 13 is a diagram of a wearable device operable to perform feedback cancellation in accordance with some examples of the present disclosure.

FIG. 14 is a diagram of earbuds operable to perform feedback cancellation in accordance with some examples of the present disclosure.

FIG. 15 is a diagram of an illustrative aspect of a system operable to perform machine-learning based audio subband processing, in accordance with some examples of the present disclosure.

FIG. 16 is a diagram of an illustrative aspect of components of a system in accordance with some examples of the present disclosure.

FIG. 17 is a diagram of an illustrative aspect of components of a system in accordance with some examples of the present disclosure.

Like reference numbers and designations in the various drawings indicate like elements.

### DETAILED DESCRIPTION

The present disclosure provides systems, apparatus, methods, and computer-readable media that support signal processing, including techniques for machine learning (ML)-based adaptive feedback cancellation to remove artifacts, such as howling, caused by feedback between a speaker and a microphone. In some embodiments, an ML model may be trained to preserve speech components and other desirable sound components (such as environment sounds) while removing other undesirable components, such as feedback components. Several embodiments are disclosed below that provide different techniques for applying an ML model to an audio signal that may be used in an amplification system. Each of the ML models may be trained to obtain processing suited for the configuration of that embodiment to provide feedback cancellation.

Particular implementations of the subject matter described in this disclosure may be implemented to realize one or more of the following potential advantages or benefits. In some aspects, the present disclosure provides techniques for improved sound quality of output audio by reducing feedback and resulting artifacts when amplifying an audio signal from a microphone in the sound field of a speaker outputting the amplified audio signal. The ML-based feedback cancellation offers improved performance by being more effective in isolating the feedback component of an audio signal while preserving desirable sound components. The effectiveness is increased, in some embodiments, because the ML-based feedback cancellation can compensate for linear and nonlinear components related to feedback.

The detailed description set forth below, in connection with the appended drawings to which the text references, is intended as a description of various embodiments and is not intended to limit the scope of the disclosure. Rather, the detailed description includes specific details for the purpose of providing a thorough understanding of the subject matter of this disclosure. It will be apparent to those skilled in the art that these specific details are not required in every case and that, in some instances, well-known structures and components are shown in block diagram form for clarity of presentation.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

An example device for recording sounds and/or processing sound signals using one or more microphones, such as a micro electrical mechanical system (MEMS) microphone, may include a configuration of one, two, three, four, or more microphones at different locations on the device. The example device may include one or more digital signal processors (DSPs), AI engines, or other suitable circuitry for processing, such as by performing certain noise cancellation operations, signals captured by the microphones. The one or more digital signal processors (DSPs) may output signals representing sounds through a bus for storage in a memory, for reproduction by an audio system, and/or for further processing by other components (such as an applications processor).

The processing circuitry may perform further processing, such as for encoding, storage, transmission, or other manipulation of the audio signals. In some embodiments, the example device may include audio circuitry including an audio amplifier (e.g., a class-D amplifier) for driving a transducer to reproduce the sounds represented by the audio signals. A speaker may be integrated with the device and coupled to the audio amplifier to be driven by the audio amplifier for reproducing the sounds. A connection may be provided by a jack or other connector on the device to couple an external transducer (e.g., an external speaker or headphones) to the audio amplifier to be driven by the audio circuitry to reproduce the sounds. In some embodiments, the jack may instead output a digital signal for conversion and amplification by an external device, such as when the jack is configured to be coupled to a digital device through a Universal Serial Bus (USB) Type-C (USB-C) connection and some or all of the audio circuitry is bypassed.

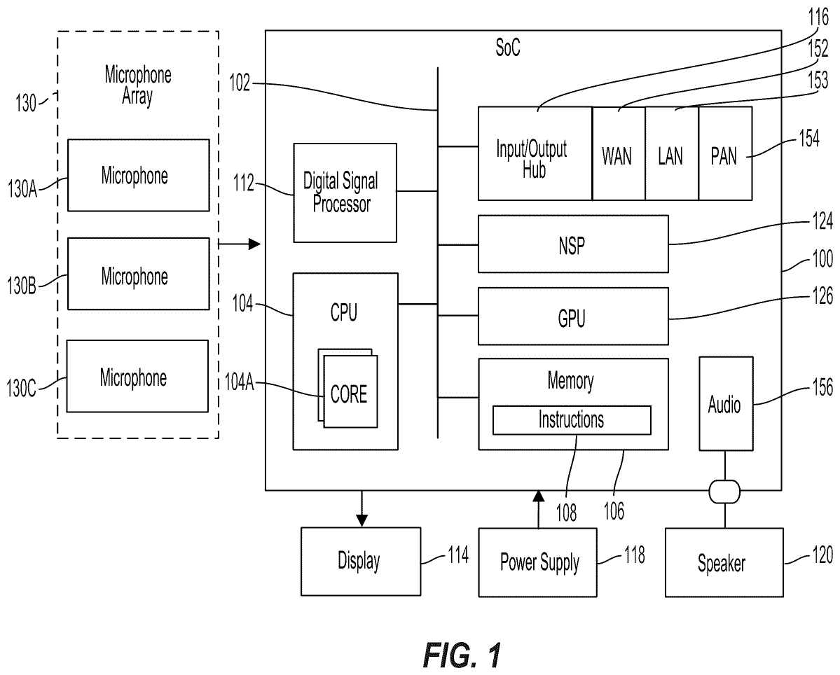

FIG. 1 shows a block diagram of a system-on-chip (SoC) configured for performing signal processing according to one or more aspects of this disclosure. The SoC 100 may include several components coupled together through a bus 102, which may be a network-on-a-chip (NoC) or a plurality of NOCs interconnecting various components. For example, although FIG. 1 illustrates several components coupled to the bus 102, the several components may be coupled to different busses with additional busses connecting the different busses to provide a path for communication between the components.

One example component in the SoC 100 is a digital signal processor (DSP) 112 for signal processing. The DSP 112 may process audio signals received from microphones 130A, 130B, and 130C of microphone array 130 (which may include one or any number of microphones although three are shown). The DSP 112 may include hardware customized for performing a limited set of operations on specific kinds of data. For example, a DSP may include transistors coupled together to perform operations on streaming data and use memory architectures and/or access techniques to fetch multiple data or instructions concurrently. Such configurations may allow the DSP 112 to operate on real-time data, such as video data, audio data, or modem data, in a power-efficient manner.

The SoC 100 also includes a central processing unit (CPU) 104 and a memory 106 storing instructions 108 (e.g., a memory storing processor-readable code or a non-transitory computer-readable medium storing instructions) that may be executed by a processor of the SoC 100. The CPU 104 may be a single central processing unit (CPU) or a CPU cluster comprising two or more cores such as core 104A. The CPU 104 may include hardware capable of performing generic operations on many kinds of data, such as hardware capable of executing instructions from the Advanced RISC Machines (ARM®) instruction set, such as ARMv8 and ARMv9. For example, a CPU 104 may include transistors coupled together to perform operations for supporting executing an operating system and user applications (e.g., a camera application, a multimedia application, a gaming application, a productivity application, a messaging application, a videocall application, an audio recording application, a video recording application). The CPU 104 may execute instructions 108 retrieved from the memory 106. In some embodiments, the CPU 104 executing an operating system may coordinate execution of instructions by various components within the SoC 100. For example, the CPU 104 may retrieve instructions 108 from memory 106 and execute the instructions on the DSP 112.

The SoC 100 may further include a neural signal processor (NSP) 124 for executing machine learning (ML) models relating to multimedia applications. The NSP 124 may include hardware configured to perform and accelerate convolution operations involved in executing machine learning algorithms. For example, the NSP 124 may improve performance when executing predictive models such as artificial neural networks (ANNs) (including multilayer feedforward neural networks (MLFFNN), the recurrent neural networks (RNN), and/or the radial basis functions (RBF)). The ANN executed by the NSP 124 may access predefined training weights stored in the memory 106 for performing operations on user data.

The SoC 100 may be coupled to a display 114 for interacting with a user. The SoC 100 may also include a graphics processing unit (GPU) 126 for rendering images on the display 114. The images may be coordinated with sound processed and output by the audio processing circuitry, such as when the SoC 100 is executing a user application for multimedia playback or gaming applications. In some embodiments, the CPU 104 may perform rendering to the display 114 without a GPU 126. In some embodiments, the GPU 126 may be configured to execute instructions for performing operations unrelated to rendering images, such as for processing large volumes of datasets in parallel.

Processing algorithms, techniques, and methods that are described herein may be executed by at least one processor of the SoC 100, which may include execution by all steps on one of the processors (e.g., DSP 112, CPU 104, NSP 124, GPU 126) or may include execution of steps across a combination of one or more of the processors (e.g., DSP 112, CPU 104, NSP 124, GPU 126). In some embodiments, at least one of the processors executes instructions to perform various operations described herein, including machine learning-based feedback cancellation. For example, execution of the instructions by the CPU 104 as part of a multimedia application (e.g., a voice recorder, a sound recording, or a video recorder) may instruct the DSP 112 to begin or end capturing audio from one or more microphones 130A-C and a digital audio signal processed in NSP 124 to reduce the presence of feedback (e.g., howling sounds) in an audio signal. The operations of the CPU 104 may be based on user input. For example, a voice recorder application executing on processor 104 may receive a user command to begin a voice recording upon which audio comprising one or more channels is captured and processed for playback and/or storage. Audio processing to determine “output” or “corrected” signals, such as according to techniques described herein, may be applied to one or more segments of audio in the recording sequence.

Input/output components may be coupled to the SoC 100 through an input/output (I/O) hub 116. An example of a hub 116 is an interconnect to a peripheral component interconnect express (PCIe) bus. Example components coupled to hub 116 may be components used for interacting with a user, such as a touch screen interface and/or physical buttons. Some components coupled to hub 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna that may be shared by each of the adaptors 152, 153, and 154, or coupled to multiple antennas configured for primary and diversity reception and/or configured for receiving specific frequency bands. In some embodiments, the WAN adaptor 152, LAN adaptor 153, and/or PAN adaptor 154 may share circuitry, such as portions of a radio frequency front end (RFFE). In some embodiments, the data transmitted through the I/O hub 116 may include audio signals processed according to aspects of this disclosure. For example, the processed audio signals may be output through WAN adaptor 152 or LAN adaptor 153 to a network media playback device or may be output through PAN adaptor 154 to a personal audio device (e.g., a user's speaker, headset, or earbuds).

Audio circuitry 156 may be integrated in SoC 100 as dedicated circuitry for coupling the SoC 100 to a speaker 120 external to the SoC 100, which may be a transducer such as a speaker (either internal to or external to a device incorporating the SoC 100) or headphones. The audio circuitry 156 may include coder/decoder (CODEC) functionality for processing digital audio signals. The audio circuitry 156 may further include one or more amplifiers (e.g., a class-D amplifier) for driving a transducer coupled to the SoC 100 for outputting sounds generated during execution of applications by the SoC 100. Functionality related to audio signals described herein may be performed by a combination of the audio circuitry 156 and/or other processors (e.g., CPU 104, DSP 112, GPU 126, NSP 124) of the SoC 100.

The SoC 100 may couple to external devices outside the package of the SoC 100. For example, the SoC 100 may be coupled to a power supply 118, such as a battery or an adaptor to couple the SoC 100 to an energy source. The signal processing described herein may be adapted to and achieve power efficiency to support operation of the SoC 100 from a limited-capacity power supply 118 such as a battery. For example, operations may be performed on a portion of the SoC 100 configured for performing the operation at a lowest power consumption. As another example, operations themselves are performed in a manner that reduces a number of computations to perform the operation, such that the algorithm is optimized for extending the operational time of a device while powered by a limited-capacity power supply 118. In some embodiments, the operations described herein may be configured based on a type of power supply 118 providing energy to the SoC 100. For example, a first set of operations may be executed to perform a function when the power supply 118 is a wall adaptor. As another example, a second set of operations may be executed to perform a function when the power supply 118 is a battery.

The SoC 100 may also include or be coupled to additional features or components that are not shown in FIG. 1. Although components are shown integrated as a single SoC 100, which may include all components built on a single semiconductor die with a common semiconductor substrate, other arrangements of the illustrated blocks different number of dies, substrates, and/or packages may be arranged to accomplish the same functionality described in this disclosure.

The memory 106 may include a non-transient or non-transitory computer readable medium storing computer-executable instructions as instructions 108 to perform all or a portion of one or more operations described in this disclosure. The instructions 108 may include a multimedia application (or other suitable application such as a messaging application) to be executed by the SoC 100 that records, processes, or outputs audio signals. The instructions 108 may also include other applications or programs executed by the SoC 100, such as an operating system and applications other than for multimedia processing.

In addition to instructions 108, the memory 106 may also store audio data. The SoC 100 may be coupled to an external memory and configured to access the memory for writing output audio files for later playback or long-term storage. For example, the SoC 100 may be coupled to a flash storage device comprising NAND memory for storing video files (e.g., MP4-container formatted files) including audio tracks and/or storing audio recordings (e.g., MPEG-1 Layer 3 files, also referred to as MP3 files). Portions of the video or audio files may be transferred to memory 106 for processing by the SoC 100, with the resulting signals after processing encoded as video or audio files in the memory 106 for transfer to the long-term storage.

While the SoC 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components.

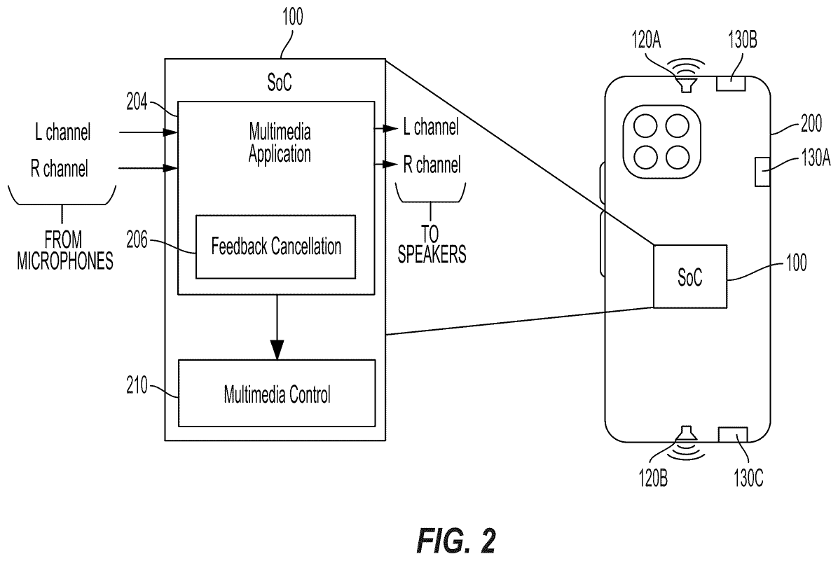

The SoC of FIG. 1 may be operated to obtain improved audio recordings and/or improved user experience through higher quality audio playback by applying feedback cancellation to an audio signal based on a machine learning (ML) model. One example method of performing multimedia operations is shown in FIG. 2 and described below.

FIG. 2 is a block diagram illustrating an example data flow path for audio signal processing in a multimedia device according to one or more aspects of the disclosure. SoC 100 of system 200 may execute multimedia control 210, such as part of an operating system or driver, to control the capture of sounds from microphones or other audio sources and/or to control the configuration of audio processing circuitry 156. The audio configuration applied by multimedia control 210 to either output devices (e.g., speakers) or input devices (e.g., microphones) may include parameters that specify, for example, a bit depth, a sampling rate, a data rate, a magnitude, or other parameters.

Multimedia control 210 may be managed by or provide services to a multimedia application 204. The multimedia application 204 may also execute on the SoC 100 including one or more processors of the SoC 100. The multimedia application 204 provides settings accessible to a user such that a user can specify individual playback settings or select a profile with corresponding playback settings. The multimedia application 204 may be, for example, a video recording application, a screen sharing application, a virtual conferencing application, an audio playback application, a messaging application, a video communications application, or other application that processes audio data. The multimedia application 204 may include feedback cancellation 206 to improve the quality of audio presented to the user during execution of multimedia application 204. The feedback cancellation 206 may perform one or more or a combination of the techniques described herein, and in some embodiments the feedback cancellation 206 may be performed by multiple processing units within the SoC 100 (such as with portions performed by DSP 112 and portions performed by NSP 124).

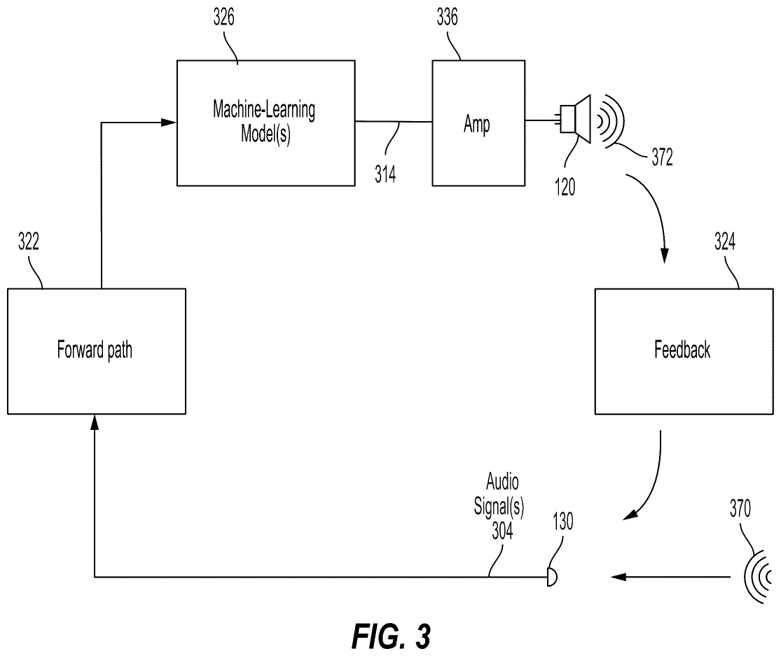

One example implementation for feedback cancellation 206 is shown in FIG. 3. FIG. 3 is a block diagram illustrating an audio system with machine learning-based feedback cancellation according to some embodiments of the disclosure. The microphone 130 may receive audio signals 370 from a source of desired audio signals. The microphone 130 may also receive feedback 324 from output audio signals 372 of the speaker 120 (or other transducer in the field of reception of microphone 130). The microphone 130 generates audio signals 304 that include a feedback component corresponding to the feedback 324 and a desired audio component corresponding to the audio signals 370. The audio signals 304 may be processed in a forward path 322, such as by amplifying the audio signals 304. The output of the forward path 322 may be processed with one or more machine learning model(s) 326 to determine output audio signals 314. The output audio signals 314 may be amplified in amplifier circuit 336 to reproduce the output audio signals 314 by the speaker 120 as sounds 372. Amplifier circuit 336 may be, for example, a Class-D Amplifier.

The machine learning model(s) 326 may be trained to preserve the desired input, such as audio signal 370, while removing artifacts resulting from the feedback 324. An example artifact is howling, which results from the amplification in forward path 322 increasing the magnitude of feedback 324 until the feedback 324 is high enough in magnitude to create an audible howling noise from the speaker 120. The feedback 324 may have linear and nonlinear components, and the machine learning model(s) 326 may be configured to cancel the linear and/or the nonlinear components. The feedback 324 may be represented by a transfer function between the speaker 120 and the microphone 130. Prior art techniques for feedback cancellation involved adaptive filters configured to estimate this transfer function. However, adaptive filters were restricted to cancelling linear components of the transfer function for feedback 324.

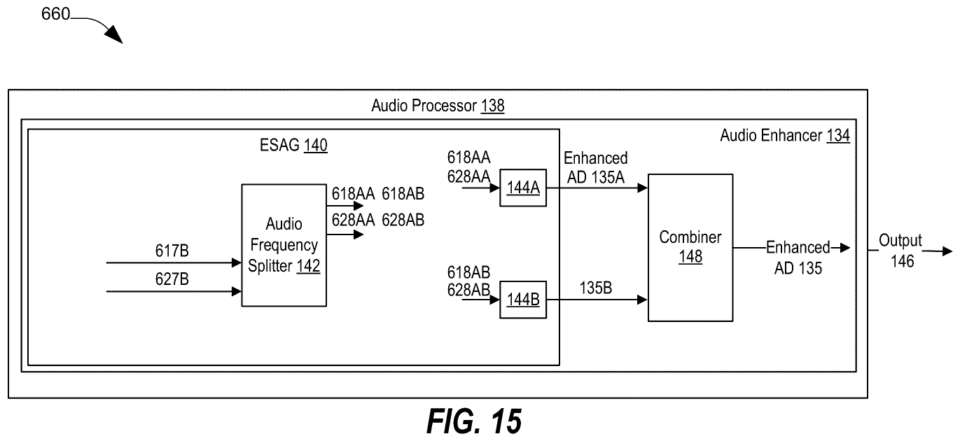

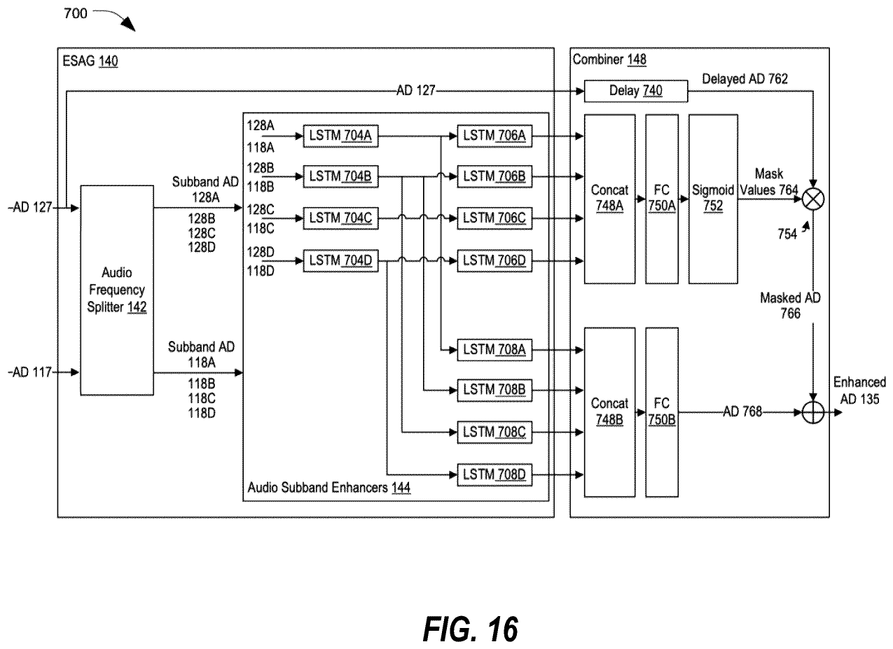

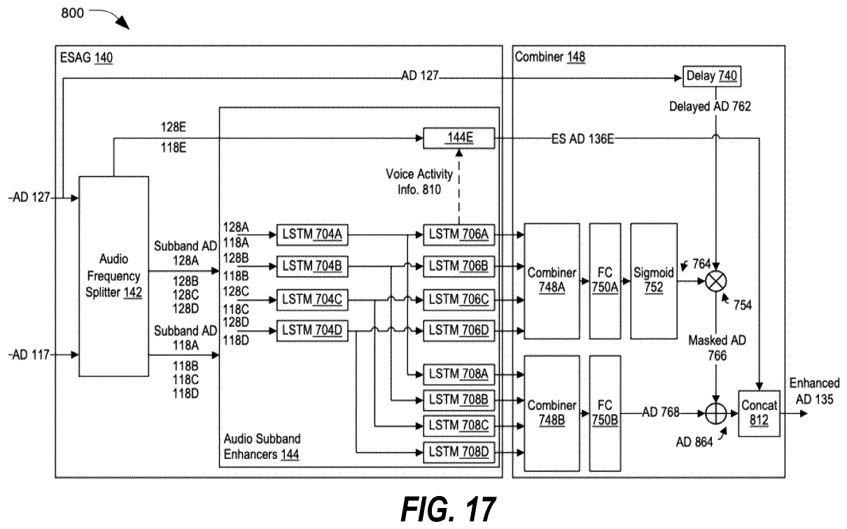

The machine learning model(s) 326 may cancel nonlinear components of the transfer function and, in some embodiments, the linear components. The machine learning model(s) 326 may also, in some embodiments, be combined with other feedback cancellation processing to further improve the audio quality of sounds 372 output from speaker 120. Example models for the machine learning model(s) 326 include masking, complex masking, SGN and its variants, including the SGN example embodiments illustrated and described with reference to FIG. 15, FIG. 16, and FIG. 17, and Unet and its variant ShrimpNet.

In some embodiments, the machine learning model(s) 326 may switch between transparency and noise cancellation modes, in which the output signals are generated by processing audio signals with different coefficients. The mode of operation (whether transparency, noise cancellation, or other) may be selected by user or determined based on one or more criteria.

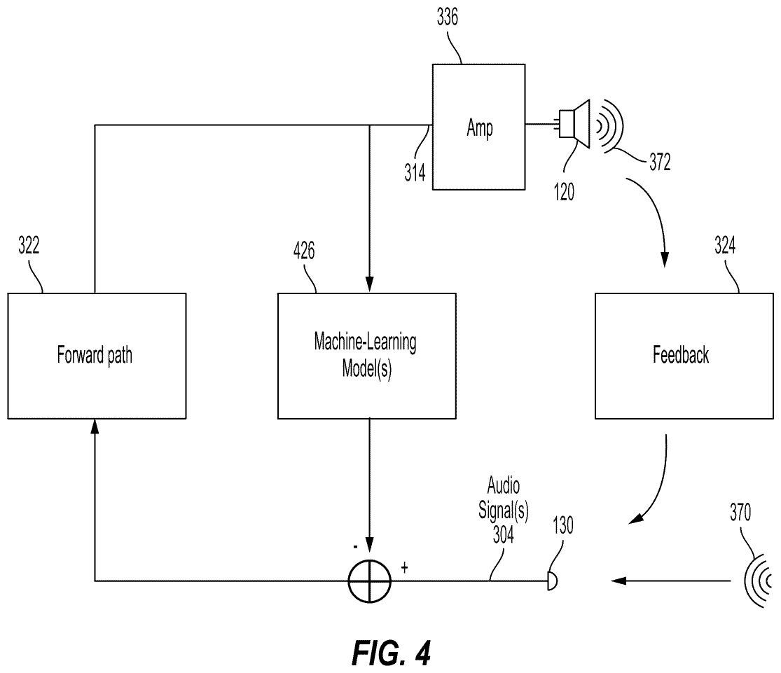

In some embodiments, the feedback cancellation is performed by the machine learning model(s) on the output of the forward path 322 as shown in FIG. 3. In other embodiments, the feedback cancellation may be applied to the audio signals 304 prior to processing in the forward path 322. An example audio system for pre-amplification feedback cancellation with machine learning models is shown in FIG. 4. FIG. 4 is a block diagram illustrating an audio system with machine learning-based feedback cancellation application before forward path processing according to some embodiments of the disclosure.

In FIG. 4, machine learning model(s) 426, which may be any of the machine learning models described with respect to FIG. 3, may modify the audio signals 304 prior to processing in forward path 322. The machine learning models 426 may determine a feedback cancellation signal to be combined with the audio signal 304 received from the microphone 130, with the combined signal processed in forward path 322. The machine learning model(s) 426 may output the feedback cancellation signal based on audio signals 314 from the output of the forward path 322 being reproduced by the speaker 120.

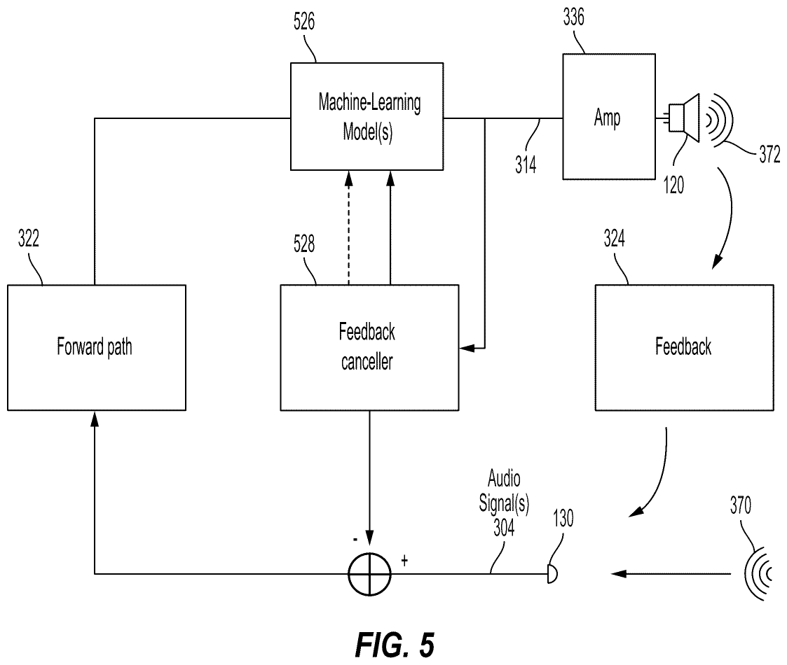

In some embodiments, the machine learning model(s) 326 may be combined with one or more adaptive filters. The combination may be configured such that the adaptive filter, which may be executed by DSP 112, removes linear components of feedback 324 and the machine learning model(s) 326, which may be executed by the NSP 124, removes nonlinear components of feedback 324. One example combination of the machine learning models with other feedback cancellation is shown in FIG. 5. FIG. 5 is a block diagram illustrating an audio system with machine learning-based feedback cancellation and other feedback cancellation according to some embodiments of the disclosure.

In FIG. 5, machine learning model(s) 526, which may be similarly configured as the machine learning model(s) 326 of FIG. 3, may modify the audio signals after processing in forward path 322. Feedback canceller 528 may determine a feedback cancellation signal for combining with the audio signals 304 prior to processing in the forward path 322. The feedback canceller 528 may be an adaptive filter that reduces linear components of feedback 324 prior to forward path 322. The machine learning model(s) 526 may be configured to reduce non-linear components of feedback 324 prior to output to speaker 120. The machine learning model(s) 526 may improve feedback cancellation performed by the audio system of FIG. 5. Although certain blocks are described as providing lincar component cancellation and/or non-linear component cancellation, each of the blocks 526 and 528 may perform cither lincar component cancellation, non-linear component cancellation, or a combination of linear and non-linear component cancellation.

The machine learning model(s) 526 may be configured to receive feedback (as input parameters relating to the feedback cancellation signal) from the feedback canceller 528. For example, an adaptive filter of feedback canceller 528 may provide information to the machine-learning model(s) 526 regarding the configuration of the adaptive filter that the machine learning model(s) 526 use as input to estimate non-linear components at the output of the forward path 322 and that estimate used to modify the output of forward path 322 to reduce artifacts such as howling. In some embodiments, the feedback canceller 528 provides to machine learning model(s) 526 an indicator as to whether howling was detected in the audio signal 304, which may be used to activate the machine learning model(s) 526. In some embodiments, the feedback canceller 528 provides to machine learning model(s) 526 one or more of F(q) FIR coefficients of the adaptive filter, D(q) coefficients of the forward path 322, open loop transfer function 1+F(q)D(q), an estimate of gain margin (e.g., a distance of the open loop transfer function from the Nyquist point (−1,0)), and/or proximity to an instability point of the adaptive filter.

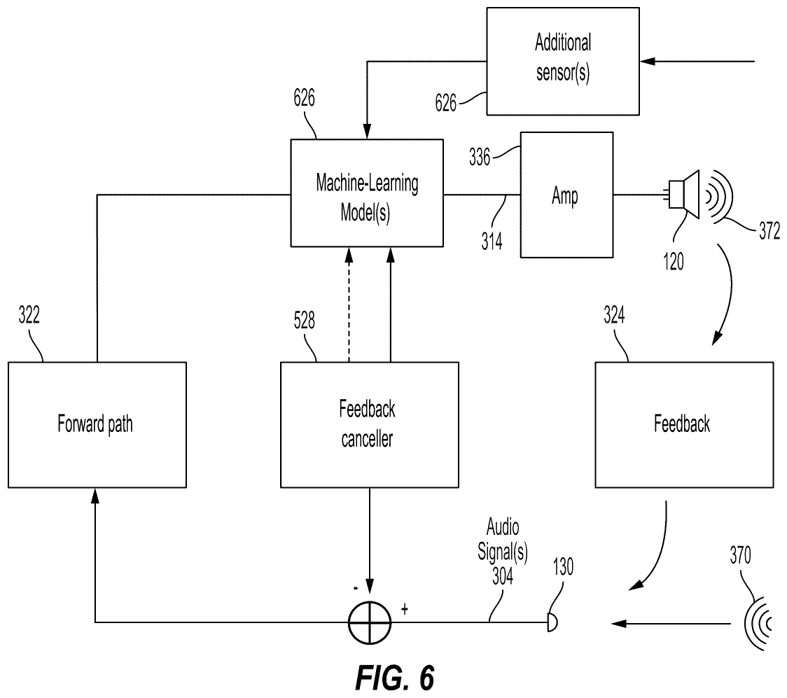

In some embodiments, the machine learning model(s) 626, which may be similarly configured as the machine learning model(s) 526 of FIG. 5, may receive information from one or more additional sensor(s) 626. FIG. 6 is a block diagram illustrating an audio system with machine learning-based feedback cancellation based on additional sensors according to some embodiments of the disclosure. Data from the additional sensor(s) 626 may be input to the machine learning model(s) 626 to improve the feedback cancellation provided by the machine learning model(s) 626. The additional sensor(s) 626 may be located outside of the path of feedback 324 or may be separated (e.g., a different modality of sensor than an audio sensor) from the feedback 324, which may improve the ability of machine learning model(s) 626 to discriminate between howling resulting from the feedback 324 processed in the forward path 322 from howling in the audio signal 370 (e.g., music, bird sounds, sirens, etc.). An example additional sensor is a camera, which receives optical signals that are not part of feedback 324.

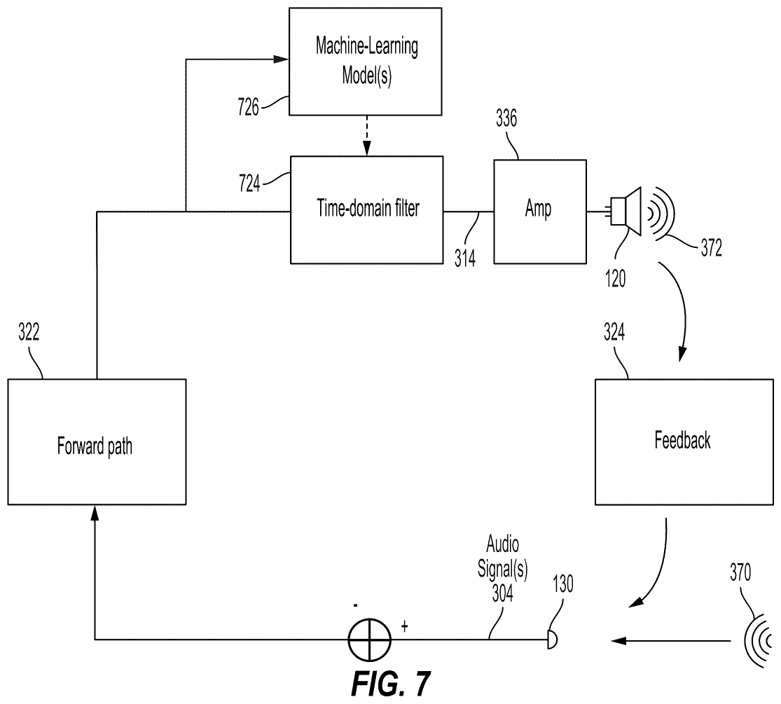

FIG. 7 is a block diagram illustrating an audio system with machine learning-based feedback cancellation applied through a time-domain filter according to some embodiments of the disclosure. This configuration for a machine learning model may reduce latency by performing analysis in the ML model in the frequency domain, with the ML model outputting coefficients for a time domain filter. In some embodiments, the machine learning model(s) 726 are trained to generate output data that includes target audio components of the frequency-domain audio data from forward path 322 and omits or suppresses non-target audio components of the frequency-domain audio data. Such models may be referred to as “inline” models. In some embodiments, the machine learning model(s) 726 are trained to generate output data that includes the non-target audio components of the frequency-domain audio data from the forward path 322 and omits or suppresses the target audio components of the frequency-domain audio data. Such models are referred to as “masking” models. Output data from masking models can be used directly as the noise-suppression output and combined with the output of the forward path 322. Output data from inline models may be further processed to generate the noise-suppression output 128.

In some embodiments, the output coefficients from the ML model may be mask coefficients. These mask coefficients may be input to a time domain filter and applied to the forward path output. In FIG. 7, machine learning model(s) 726, which may be similarly configured as machine learning model(s) 326, receives the audio signal from the forward path 322 to determine coefficients for a time domain filter 724. The time domain filter 724 also receives the output audio signal from the forward path 322 to produce output audio signals 314 for reproduction by the speaker 120.

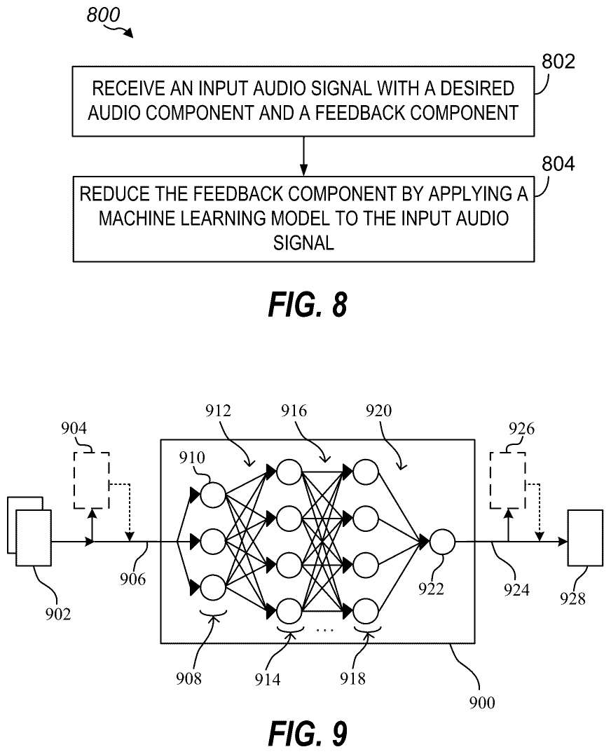

The system 200 of FIG. 2 may be configured to perform the operations described with reference to aspects of the embodiments of FIG. 3, FIG. 4, FIG. 5, FIG. 6, and/or FIG. 7 to determine an audio signal. FIG. 8 shows a flow chart of an example method for processing audio data to perform acoustic source separation according to some embodiments of this disclosure. The operations of FIG. 3 may result in an audio signal with improved representation of sounds, which results in an improved user experience. Each of the operations described with reference to FIG. 3 may be performed by one or a combination of the processors of the SoC 100.

At block 802, an input audio signals are received. The input audio signals may be received, for example, from microphones. The audio data may alternatively be received from a wireless microphone, in which the audio data is received through one or more of the WAN adaptor 152, the LAN adaptor 153, and/or the PAN adaptor 154. The audio data may alternatively be received from a memory location or a network storage location, such as when the audio signal was previously captured and is now retrieved from memory 106 and/or from a remote location through one or more of the WAN adaptor 152, the LAN adaptor 153, and/or the PAN adaptor 154. In some embodiments, the receipt (e.g., capture or retrieval) of audio signals may be initiated by multimedia application 204 executing on the SoC 100. Audio data, comprising the audio signals, may be retrieved at block 802 and further processed by the SoC 100 according to the operations described in one or more of the following blocks.

At block 804, the input audio signals are processed to reduce the feedback component by applying a machine learning model to the input audio signal received at block 802. The applying of the machine learning model to the input audio signals may be performed according to aspects of FIG. 3, FIG. 4, FIG. 5, FIG. 6, and/or FIG. 7.

The operations described with reference to blocks 802 and 804 of FIG. 8 may be performed on a digital signal processor (DSP), such as DSP 112 of the SoC 100 illustrated in FIG. 1. However, the operations may alternatively be performed by one or more of the processors of FIG. 1, including one or more of the CPU 104, the DSP 112, the GPU 126, or the NSP 124. For example, the CPU 104 may control the recording of input audio signals from the microphone array 130 to memory 106 as part of the operations of block 802. The DSP 112 and/or NSP 124 may then perform the operations of block 804 on the audio signals stored in memory 106, after which output signals determined by the DSP 112 and/or the NSP 124 may be stored in memory 106, output to audio circuitry 156 for reproduction by speaker 120, and/or transmitted to another device through one or more of the WAN 152, LAN 153, and/or PAN 154. In another example, the processor performing the operations of blocks 802 and/or 804 may be dedicated logic circuitry for performing certain operations.

Certain aspects and techniques as described herein may be implemented, at least in part, using an artificial intelligence (AI) program, e.g., a program that includes a machine learning (ML) model. For example, the machine learning model(s) 326 may implement an AI program as described with reference to FIG. 9. The ML model may be trained offline to receive an input including clean speech, unstable feedback (e.g., howling or other artifacts), and environmental sounds (e.g., sounds similar to howling). The ML model may be trained to output the clean speech and the environmental sounds without the unstable feedback (e.g., the feedback artifacts such as howling).

An example ML model may define computing capabilities for making determinations from input data, with the determinations made based on patterns identified in the input data. The computing capabilities may be defined in terms of weights and biases. Weights may indicate relationships between certain input data and certain determinations. Biases may indicate a starting point for determinations. An example ML model operating on input data may start at a determination defined by the biases and then change its determination based on a combination of the input data and the weights. The determinations from an ML model may be one or more of decisions, predictions, inferences, or values. The decisions, predictions, or inferences may be represented as values output from an ML model. In some embodiments of this disclosure, an ML model may be configured to provide computing capabilities for feedback cancellation in audio signal processing. Such an ML model may be configured with weights and/or biases to perform feedback cancellation by recognizing desirable aspects of audio (e.g., speech and environmental sounds) and reducing or eliminating undesirable aspects of audio (e.g., feedback artifacts). Thus, during operation of a device, the ML model may receive input data (e.g., microphone signals) and make determinations (e.g., output audio signals with reduced feedback artifacts) based on the weights and/or biases. ML models that may be configured in this manner according to embodiments of this disclosure include supervised ML models and unsupervised ML models and ML models for classification and/or regression.

The description herein illustrates, by way of some examples, how one or more tasks/problems in feedback cancellation in audio signal processing may benefit from the application of one or more ML models using an ANN. In some embodiments, other type(s) of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

FIG. 9 is an illustrative block diagram of an example machine learning (ML) model represented by an artificial neural network (ANN) 900. ANN 900 may receive input data 906 which may include one or more bits of data 902, pre-processed data output from pre-processor 904 (optional), or some combination thereof. Here, data 902 may include training data, verification data, application-related data, or the like, e.g., depending on the stage of deployment of ANN 900. Pre-processor 904 may be included within ANN 900 in some other implementations. Pre-processor 904 may, for example, process all or a portion of data 902 which may result in some of data 902 being changed, replaced, deleted, etc. In some implementations, pre-processor 904 may add additional data to data 902. In some implementations, the pre-processor 904 may be an ML model, such as an ANN.

ANN 900 includes at least one first layer 908 of artificial neurons 910 to process input data 906 and provide resulting first layer data via edges 912 to at least a portion of at least one second layer 914. Second layer 914 processes data received via edges 912 and provides second layer output data via edges 916 to at least a portion of at least one third layer 918. Third layer 918 processes data received via edges 916 and provides third layer output data via edges 920 to at least a portion of a final layer 922 including one or more neurons to provide output data 924. All or part of output data 924 may be further processed in some manner by (optional) post-processor 926. Thus, in certain examples, ANN 900 may provide output data 928 that is based on output data 924, post-processed data output from post-processor 926, or some combination thereof. Post-processor 926 may be included within ANN 900 in some other implementations. Post-processor 926 may, for example, process all or a portion of output data 924 which may result in output data 928 being different, at least in part, to output data 924, e.g., as result of data being changed, replaced, deleted, etc. In some implementations, post-processor 926 may be configured to add additional data to output data 924. In this example, second layer 914 and third layer 918 represent intermediate or hidden layers that may be arranged in a hierarchical or other like structure. Although not explicitly shown, there may be one or more further intermediate layers between the second layer 914 and the third layer 918. In some implementations, the post-processor 926 may be an ML model, such as an ANN.

ANN 900 or other ML models may be implemented in various types of processing circuits along with memory and applicable instructions therein. For example, general-purpose hardware circuits, such as, such as one or more central processing units (CPUs) and one or more graphics processing units (GPUs) may be employed to implement a model. One or more tensor processing units (TPUs), neural processing units (NPUs), or other special-purpose processors, and/or field-programmable gate arrays (FPGAs), application-specific integrated circuits (ASICs), or the like also or alternatively may be employed. In some implementations, the ML model may be implemented by an NPU and/or a TPU embedded in a system on chip (SoC) along with other components, such as one or more CPUs and/or GPUs. A SoC includes several components manufactured on a shared semiconductor substrate. The NPU and/or TPU may be controlled by the one or more CPUs by configuring the ML model implemented by the NPU and/or TPU with weights and/or biases, providing certain training data to the ML model to configure the ML model, and/or providing input data to the ML model to obtain determinations. The one or more CPUs may also receive the determinations and be configured to perform certain actions based on the determinations made by the ML model.

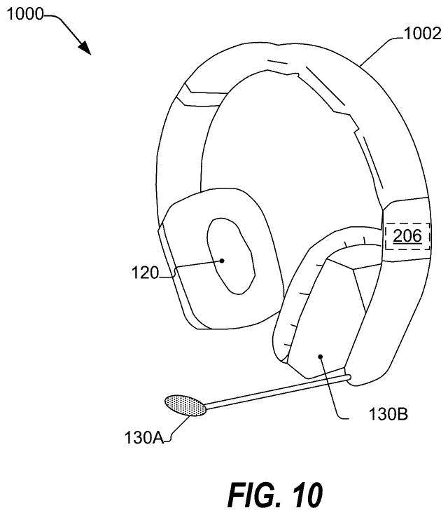

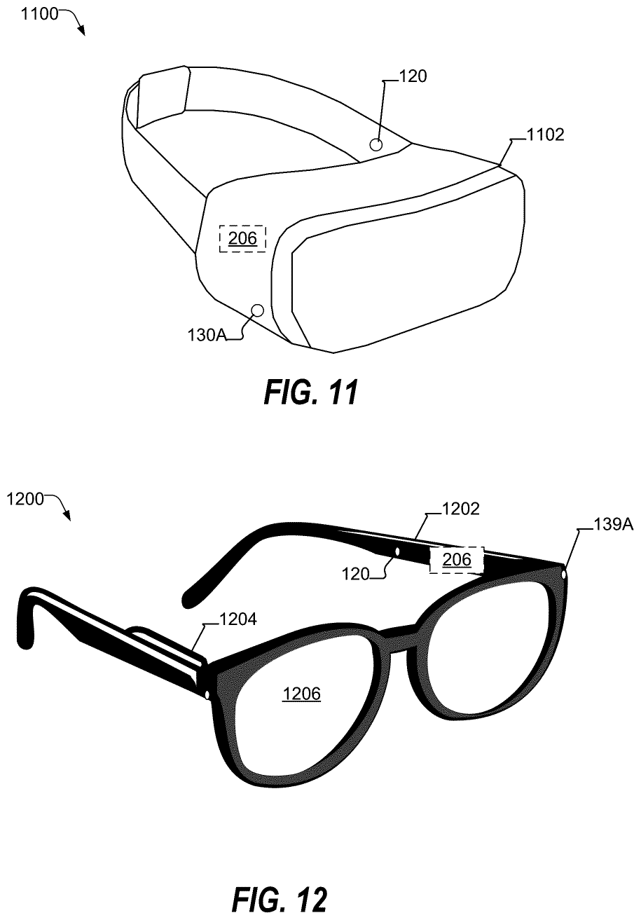

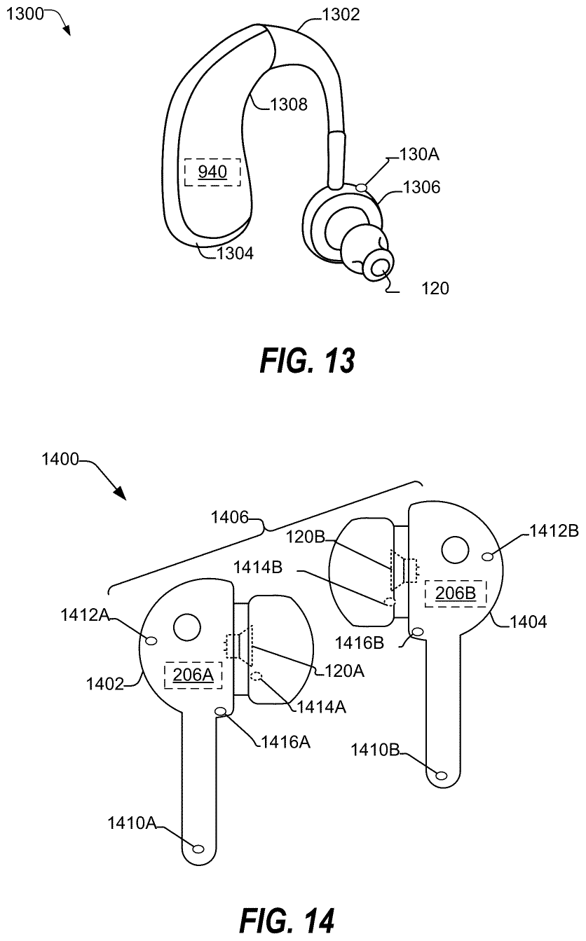

Aspects of the signal processing described in FIG. 3, FIG. 4, FIG. 5, FIG. 6, and/or FIG. 7 may be incorporated in example devices, such as the example device of FIG. 10, FIG. 11, FIG. 12, FIG. 13, and FIG. 14. Examples of such wearable devices include, without limitation, a headset device as described further with reference to FIG. 10; a virtual reality, mixed reality, or augmented reality headset as described with reference to FIG. 11; augmented reality glasses as described with reference to FIG. 12; a hearing aid device as described with reference to FIG. 13; or earbuds as described with reference to FIG. 14.

FIG. 10 depicts an implementation 1000 of a headset device 1002, which may include the SoC 100 configured according to one of FIG. 2, FIG. 3, FIG. 4, FIG. 5, FIG. 6, FIG. 7, and/or FIG. 8. The headset device 1002 includes the microphone(s) 130 and the speaker(s) 120. In the example illustrated in FIG. 10, the microphone 130A is positioned primarily to detect speech from a person wearing the headset device 1002, and the microphone 130B is positioned to detect ambient sound, such as speech from another person or other sounds. Components of the SoC 100, including feedback cancellation 206, are integrated in the headset device 1002 and depicted using dashed lines to indicate components not generally visible to a user of the headset device 1002.

In a particular example of operation, the microphone 130B can detect sound in an environment around the headset device 1002 and generate audio data representing the sound. The audio data can be provided to the SoC 100, which can process the audio data in the time domain to generate a noise-suppressed output signal and can process the audio data in the frequency domain to generate (or update) time-domain filter coefficients that are applied to subsequently received audio data. In this example, the time-domain filter coefficients determined via frequency-domain processing provide high-quality noise suppression, and since the time-domain filter coefficients are applied to received audio data in the time domain, little or no latency is added by using such time-domain filter coefficients to process the audio data. Thus, the headset device 1002 can provide high-quality, low-latency noise suppression.

FIG. 11 depicts an implementation 1100, which includes a portable electronic device that corresponds to a virtual reality, mixed reality, or augmented reality headset device 1102. The headset device 1102 includes the microphone(s) 130 and the speaker(s) 120. Additionally, components of the SoC 100, including the feedback cancellation 206, are integrated in the headset device 1102. In a particular example of operation, the microphone(s) 130 can detect sound in an environment around the headset device 1102 and generate audio data representing the sound. The audio data can be provided to the SoC 100, which can process the audio data in the time domain to generate a noise-suppressed output signal and can process the audio data in the frequency domain to generate (or update) time-domain filter coefficients that are applied to subsequently received audio data. In this example, the time-domain filter coefficients determined via frequency-domain processing provide high-quality noise suppression, and since the time-domain filter coefficients are applied to receive audio data in the time domain, little or no latency is added by using such time-domain filter coefficients to process the audio data. Thus, the headset device 1102 can provide high-quality, low-latency noise suppression.

FIG. 12 depicts an implementation 1200, which corresponds to augmented reality or mixed reality glasses 1202. The glasses 1202 include a holographic projection unit 1204 configured to project visual data onto a surface of a lens 1206 or to reflect the visual data off of a surface of the lens 1206 and onto the wearer's retina. The glasses 1202 also include the microphone(s) 130, the speaker(s) 120, and the SoC 100.

In a particular example of operation, the microphone(s) 130 can detect sound in an environment around the glasses 1202 and generate audio data representing the sound. The audio data can be provided to the feedback cancellation 206, which can process the audio data in the time domain to generate a noise-suppressed output signal and can process the audio data in the frequency domain to generate (or update) time-domain filter coefficients that are applied to subsequently received audio data. In this example, the time-domain filter coefficients determined via frequency-domain processing provide high-quality noise suppression, and since the time-domain filter coefficients are applied to receive audio data in the time domain, little or no latency is added by using such time-domain filter coefficients to process the audio data. Thus, the glasses 1202 can provide high-quality, low-latency noise suppression.

In some implementations, the holographic projection unit 1204 may display information related to the sound detected by the microphone(s) 130. For example, the holographic projection unit 1204 can display a notification indicating that speech has been detected. In another example, the holographic projection unit 1204 can display a notification indicating a detected audio event. For example, the notification can be superimposed on the user's field of view at a particular position that coincides with the location of the source of the sound associated with the audio event.

FIG. 13 is a diagram of a wearable device operable to perform low-latency noise suppression, in accordance with some examples of the present disclosure. In the example illustrated in FIG. 13, the wearable device is a hearing aid device 1302. The hearing aid device 1302 includes the microphone(s) 130, the speaker(s) 120, and the SoC 100, which includes the feedback cancellation 206. In the example illustrated in FIG. 13, the hearing aid device 1302 is shown, which is configured to be worn behind an car of the user, a portion 1308 configured to extend over the car, and a portion 1306 to be worn at or near an car canal of the user. In other examples, the hearing aid device 1302 has a different configuration or form factor. To illustrate, the hearing aid device 1302 can be an in-car device that does not include the portion 1304 configured to be worn behind an car and the portion 1308 configured to extend over the car.

In a particular example of operation of the hearing aid device 1302, the microphone(s) 130 can detect sound in an environment around the hearing aid device 1302 and generate audio data representing the sound. The audio data can be provided to the audio components 940, which can process the audio data in the time domain to generate a noise-suppressed output signal and can process the audio data in the frequency domain to generate (or update) time-domain filter coefficients that are applied to subsequently received audio data. In this example, the time-domain filter coefficients determined via frequency-domain processing provide high-quality noise suppression, and since the time-domain filter coefficients are applied to receive audio data in the time domain, little or no latency is added by using such time-domain filter coefficients to process the audio data. Thus, the hearing aid device 1302 can provide high-quality, low-latency noise suppression.

FIG. 14 depicts an implementation 1400, which includes a portable electronic device that corresponds to one or more earbuds 1406 (e.g., a first earbud 1402, a second carbud 1404, or both). Although carbuds 1406 are described, it should be understood that the present technology can be applied to other in-ear or over-car audio devices.

In the example illustrated in FIG. 14, the first carbud 1402 includes a first microphone 1410A, such as a high signal-to-noise microphone positioned to capture the voice of a wearer of the first carbud 1402, one or more other microphones configured to detect ambient sounds and spatially distributed to support beamforming, illustrated as microphone(s) 1412A, an “inner” microphone 1414A proximate to the wearer's ear canal (e.g., to assist with active noise cancelling), and a self-speech microphone 1416A, such as a bone conduction microphone configured to convert sound vibrations of the wearer's car bone or skull into an audio signal.

The second earbud 1404 can be configured in a substantially similar manner as the first carbud 1402. For example, the second earbud can include a microphone 1410B positioned to capture the voice of a wearer of the second carbud 1404, one or more other microphones 1412B configured to detect ambient sounds and spatially distributed to support beamforming, an “inner” microphone 1414B, and a self-speech microphone 1416B.

In some implementations, the carbuds 1402, 1404 are configured to automatically switch between various operating modes, such as a passthrough mode in which ambient sound is processed, by the audio components 940, for output via a speaker(s) 120, and a playback mode in which non-ambient sound (e.g., streaming audio corresponding to a phone conversation, media playback, video game, etc.) is played back through the speaker(s) 120. In other implementations, the earbuds 1402, 1404 may support fewer modes or may support one or more other modes in place of, or in addition to, the described modes. In an illustrative example of operation in the passthrough mode, one or more of the microphone(s) 130 (e.g., the microphone(s) 1412A, 1412B) can detect sound in an environment around the carbuds 1402, 1404 and generate audio data representing the sound.

The audio data can be provided to feedback cancellation 206, which can process the audio data with a machine learning model in the time domain to generate a noise-suppressed output signal and can process the audio data in the frequency domain to generate (or update) time-domain filter coefficients that are applied to subsequently received audio data. In this example, the time-domain filter coefficients determined via frequency-domain processing provide high-quality noise suppression, and since the time-domain filter coefficients are applied to received audio data in the time domain, little or no latency is added by using such time-domain filter coefficients to process the audio data. Thus, the carbuds 1402, 1404 can provide high-quality, low-latency noise suppression.

Referring to FIG. 15, a diagram is shown of an illustrative aspect of a system 660 operable to perform machine-learning based audio subband processing. In a particular aspect, the system FIGS. 1-14 can include one or more components of the system 660. The audio frequency splitter 142 generates subband audio data for audio data. For example, the audio frequency splitter 142 processes audio data 617B to generate subband audio data 618AA associated with a first frequency subband and subband audio data 618AB associated with a second frequency subband. The subband audio data 618AA represents the first frequency subband of audio captured by a microphone. The subband audio data 618AB represents the second frequency subband of audio captured by a microphone.

Additionally, the audio frequency splitter 142 processes audio data 627B to generate subband audio data 628AA associated with the first frequency subband and subband audio data 628AB associated with the second frequency subband. The subband audio data 628AA represents the first frequency subband of audio captured by one of the microphones. The subband audio data 628AB represents the second frequency subband of audio captured by one of the microphones.

One or more audio subband enhancers 144 process sets of subband audio data associated with a corresponding frequency subband to generate enhanced audio data of the frequency subband. For example, the audio subband enhancer 144A processes subband audio data of the first frequency subband to generate enhanced audio data 135A. To illustrate, the audio subband enhancer 144A processes the subband audio data 618AA and the subband audio data 628AA to generate the enhanced audio data 135A. As another example, the audio subband enhancer 144B processes the subband audio data 618AB and the subband audio data 628AB to generate enhanced audio data 135B.

Referring to FIG. 16, a diagram 700 is shown of an illustrative aspect of components of a system. In a particular aspect, the diagram 700 includes an example of an illustrative optional embodiment of the enhanced subband audio generator 140 and an example of an illustrative optional embodiment of the combiner 148.

The audio subband enhancers 144 include a plurality of machine-learning models (e.g., LSTMs) associated with respective subbands. For example, an LSTM 704A coupled to an LSTM 706A and an LSTM 708A corresponds to an audio subband enhancer 144A associated with a first frequency subband. As another example, an LSTM 704B coupled to an LSTM 706B and an LSTM 708B corresponds to an audio subband enhancer 144B associated with a second frequency subband. As yet another example, an LSTM 704C coupled to an LSTM 706C and an LSTM 708C corresponds to an audio subband enhancer 144C associated with a third frequency subband. In an additional example, an LSTM 704D coupled to an LSTM 706D and an LSTM 708D corresponds to an audio subband enhancer 144D associated with a fourth frequency subband. It should be understood that the enhanced subband audio generator 140 including audio subband enhancers 144 corresponding to four frequency subbands is provided as an illustrative example, in other examples the enhanced subband audio generator 140 can include audio subband enhancers 144 associated with fewer than four frequency subbands or more than four frequency subbands.

The combiner 148 includes a concatenation layer 748A coupled to a fully connected layer 750A. The combiner 148 also includes a concatenation layer 748B coupled to a fully connected layer 750B. The audio subband enhancer 144A processes audio data (e.g., the subband audio data 118A, the subband audio data 128A, one or more additional sets of subband audio data, or a combination thereof) representing the first frequency subband to generate an output that is provided to each of the LSTM 706A and the LSTM 708A of the audio subband enhancer 144A.

The audio frequency splitter 142 processes the audio data 117 to generate subband audio data 118A, subband audio data 118B, subband audio data 118C, and subband audio data 118D corresponding to the first frequency subband, the second frequency subband, the third frequency subband, and the fourth frequency subband, respectively. The audio frequency splitter 142 processes the audio data 127 to generate subband audio data 128A, subband audio data 128B, subband audio data 128C, and subband audio data 128D corresponding to the first frequency subband, the second frequency subband, the third frequency subband, and the fourth frequency subband, respectively.

The audio frequency splitter 142 provides subband audio data of a frequency subband to a corresponding LSTM 704. For example, the audio frequency splitter 142 provides the subband audio data 118A, the subband audio data 128A, or both, to the LSTM 704A. As another example, the audio frequency splitter 142 provides the subband audio data 118B, the subband audio data 128B, or both, to the LSTM 704B. An output of a LSTM 704 is provided to the corresponding LSTM 706, the corresponding LSTM 708, or both. For example, an output of the LSTM 704A is provided to the LSTM 706A, the LSTM 708A, or both.

Outputs of the LSTMs 706 are provided to the concatenation layer 748A and outputs of the LSTMs 708 are provided to the concatenation layer 748B. For example, an output of the LSTM 706A is provided to the concatenation layer 748A and an output of the LSTM 708A is provided to the concatenation layer 748B. In a particular aspect, the output of the LSTM 706A, the output of the LSTM 708A, or both, correspond to the enhanced subband audio data 136A.

The concatenation layer 748A concatenates outputs of the LSTM 706A, the LSTM 706B, the LSTM 706C, the LSTM 706D, one or more additional LSTMs, or a combination thereof, to generate first concatenated audio data representing a frequency band. In an example, the frequency band includes the first frequency subband, the second frequency subband, the third frequency subband, the fourth frequency subband, one or more additional frequency subbands, or a combination thereof. The first concatenated audio data is processed by the fully connected layer 750A. The combiner 148 applies a sigmoid function 752 to an output of the fully connected layer 750A to generate mask values 764. For example, an output of the fully connected layer 750A includes a first count of values (e.g., 257 integer values). Applying the sigmoid function 752 to the output of the fully connected layer 750A generates the first count of mask values 764 (e.g., 257 mask values). In a particular optional embodiment, a mask value is either a 0 or a 1.

The combiner 148 applies a delay 740 to the audio data 127 to generate delayed audio data 762. The combiner 148 includes a multiplier 754 that applies the mask values 764 to the delayed audio data 762 to generate masked audio data 766. For example, the delayed audio data 762 includes the first count of values (e.g., 257 values) and applying the mask values 764 to the delayed audio data 762 includes applying a first mask value to a first value of the delayed audio data 762 to generate a first value of the masked audio data 766. In a particular optional embodiment, if the first mask value is 0, the first value of the masked audio data 766 is 0. Alternatively, if the first mask value is 1, the first value of the masked audio data 766 is the same as the first value of the delayed audio data 762. The mask values 764 thus enable selected values of the delayed audio data 762 to be included in the masked audio data 766.

The concatenation layer 748B concatenates outputs of the LSTM 708A, the LSTM 708B, the LSTM 708C, the LSTM 708D, one or more additional LSTMs, or a combination thereof, to generate second concatenated audio data representing the frequency band. The second concatenated audio data is processed by the fully connected layer 750B to generate audio data 768. The combiner 148 generates the enhanced audio data 135 based on a combination of the masked audio data 766 and the audio data 768.

In a particular optional embodiment, model architectures of the audio subband enhancers 144 are based on the subband enhancer data 346. In an example, each of the LSTMs of the audio subband enhancer 144A includes two hidden layers, each of the LSTMs of the audio subband enhancer 144B includes two hidden layers, each of the LSTMs of the audio subband enhancer 144C includes four hidden layers, and each of the LSTMs of the audio subband enhancer 144D includes four hidden layers. In a particular aspect, the audio subband enhancers 144 and the combiner 148 correspond to a SGN. In a particular aspect, the audio subband enhancers 144 include multiple LSTMs for generating enhanced audio data of respective subbands that are smaller as a group than a single LSTM that is configured to generate enhanced audio data for all of the frequency band.

It should be understood that applying the delay 740 to the audio data 127 to generate the delayed audio data 762 is provided as an illustrative example. In another example, the delay 740 can be applied to the audio data 117, the audio data 127, or a combination thereof, to generate the delayed audio data 762.

Referring to FIG. 17, a diagram 800 is shown of an illustrative aspect of operation of components of a system. In a particular aspect, the diagram 800 includes an example of an illustrative optional implementation of the enhanced subband audio generator 140 and an example of an illustrative optional implementation of the combiner 148.

In a particular optional embodiment, one or more of the audio subband enhancers 144 are configured to perform procedural signal processing. For example, the audio subband enhancers 144 include an audio subband enhancer 144E configured to use procedural signal processing to process audio data of a fifth frequency subband to generate enhanced subband audio data 136E of the fifth frequency subband.

In an illustrative example, the audio frequency splitter 142 processes the audio data 117 to generate subband audio data 118E of a fifth frequency subband in addition to generating the subband audio data 118A, the subband audio data 118B, the subband audio data 118C, and the subband audio data 118D. The audio frequency splitter 142 processes the audio data 127 to generate subband audio data 128E of the fifth frequency subband in addition to generating the subband audio data 118A, the subband audio data 118B, the subband audio data 118C, and the subband audio data 118D. The audio frequency splitter 142 generating audio data associated with five frequency subbands is provided as an illustrative example, in other examples the audio frequency splitter 142 can generate audio data associated with fewer than five or more than five frequency subbands.

The audio subband enhancer 144E applies procedural signal processing to the subband audio data 118E, the subband audio data 128E, or a combination thereof, to generate the enhanced subband audio data 136E. In an optional embodiment, the audio subband enhancer 144E applies the procedural signal processing based on voice activity information 810 from one or more of the audio subband enhancers 144A-D. In a particular aspect, the fifth frequency subband (e.g., 8-16 kHz) corresponds to a higher frequency range and subband SGN processing (e.g., using generative networks, such as LSTMs) is bypassed for the higher frequency range because speech in the higher frequency range appears similar to noise to generative networks. In some optional embodiments, the audio subband enhancer 144E includes a machine-learning model other than a generative network.

The combiner 148 generates audio data 864 based on a combination of the masked audio data 766 and the audio data 768. The audio data 864 is of a particular frequency subband (e.g., the first frequency subband, the second frequency subband, the third frequency subband, and the fourth frequency subband). The combiner 148 includes a concatenation layer 812 that concatenates the audio data 864 and the enhanced subband audio data 136E to generate the enhanced audio data 135. The enhanced audio data 135 is of a frequency band (e.g., the particular frequency subband and the fifth frequency subband).

In one or more aspects, techniques for supporting signal processing may include additional aspects, such as any single aspect or any combination of aspects described below or in connection with one or more other processes or devices described elsewhere herein. In a first aspect, supporting signal processing may include an apparatus configured for feedback reduction. The apparatus is further configured to perform feedback reduction using a trained machine learning (ML) model that determines an output audio signal by combining an output of the ML model with a microphone signal to reduce feedback components in the microphone signal.

Additionally, the apparatus may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the apparatus is further configured to receive an input audio signal, wherein the input audio signal includes a desired audio component and a feedback component; and determine an output audio signal by applying a machine learning model to the input audio signal, in which the machine learning model is configured to reduce the feedback component.

In a third aspect, in combination with one or more of the first aspect or the second aspect, the machine learning model is configured to preserve the desired component and remove the feedback component.

In a fourth aspect, in combination with one or more of the first aspect through the third aspect, the apparatus further includes an amplification circuit coupled to the one or more processors and configured to drive a transducer from the output audio signal.

In a fifth aspect, in combination with one or more of the first aspect through the fourth aspect, the one or more processors are configured to reduce the feedback component by causing the combination of the input audio signal with a cancellation signal generated by the machine learning model to determine the output audio signal, and the machine learning model is configured to generate the cancellation signal to cancel nonlinearities created by the amplification circuit amplifying the output audio signal.

In a sixth aspect, in combination with one or more of the first aspect through the fifth aspect, the one or more processors are further configured to determine a feedback cancellation signal to reduce linear components of the feedback component of the input audio signal; and combine the feedback cancellation signal with the input audio signal prior to determining the output audio signal by applying the machine learning model.

In a seventh aspect, in combination with one or more of the first aspect through the sixth aspect, the apparatus further comprises an amplification circuit coupled to the one or more processors and configured to amplify the output audio signal to drive a transducer from the output audio signal, wherein the machine learning model is configured to reduce the feedback component by reducing nonlinearities of the amplification circuit.

In an eighth aspect, in combination with one or more of the first aspect through the seventh aspect, the apparatus further comprises an additional amplification circuit coupled to the one or more processors and configured to amplify the input audio signal after combining the feedback cancellation signal with the input audio signal and before reducing the feedback component by applying the machine learning model, and wherein the machine learning model is configured to reduce the feedback component by reducing nonlinearities of the additional amplification circuit.

In a ninth aspect, in combination with one or more of the first aspect through the eighth aspect, the machine learning model is configured to reduce the feedback component based on parameters relating to the feedback cancellation signal.

In a tenth aspect, in combination with one or more of the first aspect through the ninth aspect, the one or more processors comprise a digital signal processor configured to determine the feedback cancellation signal and to output the parameters relating to the feedback cancellation signal; and a neural signal processor configured to execute the machine learning model based on the parameters relating to the feedback cancellation signal.

In an eleventh aspect, in combination with one or more of the first aspect through the tenth aspect, the machine learning model is configured to reduce the feedback component based on input parameters corresponding to input from a sensor uncorrelated with the feedback component.

In a twelfth aspect, in combination with one or more of the first aspect through the eleventh aspect, the machine learning model is configured to reduce one or more artifacts resulting from the amplification circuit without reducing other howling in the input audio signal.

In a thirteenth aspect, in combination with one or more of the first aspect through the twelfth aspect, the one or more processors are configured to reduce the feedback component by applying the machine learning model comprises applying a time-domain filter to the input audio signal after the amplifying of the input audio signal, the time-domain filter configured based on the machine learning model.

In a fourteenth aspect, in combination with one or more of the first aspect through the thirteenth aspect, the apparatus further comprising a first microphone coupled to the one or more processors, wherein the input audio signal is received from the first microphone; and a transducer coupled to the one or more processors, wherein the transducer is configured to reproduce the output audio signal.

In a fifteenth aspect, in combination with one or more of the first aspect through the fourteenth aspect, a method comprises receiving an input audio signal, wherein the input audio signal includes a desired audio component and a feedback component; and reducing the feedback component by applying a machine learning model to the input audio signal to determine an output audio signal.

In a sixteenth aspect, in combination with one or more of the first aspect through the fifteenth aspect, the machine learning model is configured to preserve the desired component and remove the feedback component.

In a seventeenth aspect, in combination with one or more of the first aspect through the sixteenth aspect, the method further including amplifying the output audio signal for output to a transducer, wherein reducing the feedback component comprises combining the input audio signal with a cancellation signal generated by the machine learning model to determine the output audio signal prior to amplifying the output audio signal, and wherein the machine learning model is configured to generate the cancellation signal to cancel nonlinearities created by amplifying the output audio signal.

In an eighteenth aspect, in combination with one or more of the first aspect through the seventeenth aspect, the method further including determining a feedback cancellation signal to reduce linear components of the feedback component of the input audio signal; combining the feedback cancellation signal with the input audio signal prior to reducing the feedback component by applying the machine learning model; and amplifying the output audio signal to drive a transducer from the output audio signal, wherein the machine learning model is configured to reduce the feedback component by reducing nonlinearities of amplifying the output audio signal.

In a nineteenth aspect, in combination with one or more of the first aspect through the eighteenth aspect, the method further comprising: amplifying the input audio signal after combining the feedback cancellation signal with the input audio signal and before reducing the feedback component by applying the machine learning model, wherein the machine learning model is configured to reduce the feedback component by reducing nonlinearities of amplifying the input audio signal.

In a twentieth aspect, in combination with one or more of the first aspect through the nineteenth aspect, the machine learning model is configured to reduce the feedback component based on input parameters relating to the feedback cancellation signal.

In a twenty-first aspect, in combination with one or more of the first aspect through the twentieth aspect, the machine learning model is configured to reduce the feedback component based on input parameters corresponding to input from a sensor uncorrelated with the feedback component.

In a twenty-second aspect, in combination with one or more of the first aspect through the twenty-first aspect, the amplifying results in one or more artifacts resulting from the feedback component in the input audio signal, the one or more artifacts comprising howling, and the machine learning model is configured to reduce the one or more artifacts resulting from the amplifying without reducing other howling in the input audio signal.

In a twenty-third aspect, in combination with one or more of the first aspect through the twenty-second aspect, the method further including amplifying the input audio signal, wherein the amplifying results in one or more artifacts resulting from the feedback component in the input audio signal, and wherein the machine learning model is configured to reduce the one or more artifacts.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIG. 3 may be combined with one or more blocks (or operations) described with reference to another of the figures. For example, one or more blocks (or operations) of FIG. 3 may be combined with one or more blocks (or operations) of FIG. 1 or FIG. 2. As another example, one or more blocks associated with FIGS. 4-9 may be combined with one or more blocks (or operations) associated with FIGS. 1-3. As a further example, one or more blocks associated with FIGS. 15-17 may be combined with one or more blocks (or operations) associated with FIGS. 3-9. As yet another example, one or more blocks associated with FIGS. 10-14 may be combined with one or more blocks (or operations) associated with FIGS. 1-2 and/or FIGS. 3-9.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc wherein disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes .1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus, comprising:
a memory storing processor-readable code; and
one or more processors coupled to the memory, the one or more processors configured to:
receive an input audio signal, wherein the input audio signal includes a desired audio component and a feedback component; and
determine an output audio signal by applying a machine learning model to the input audio signal, in which the machine learning model is configured to reduce the feedback component.

2. The apparatus of claim 1, wherein the machine learning model is configured to preserve a desired component.

3. The apparatus of claim 1, further comprising an amplification circuit coupled to the one or more processors and configured to drive a transducer from the output audio signal, wherein:
the one or more processors are configured to reduce the feedback component by causing the combination of the input audio signal with a cancellation signal generated by the machine learning model to determine the output audio signal, and
the machine learning model is configured to generate the cancellation signal to cancel nonlinearities created by the amplification circuit amplifying the output audio signal.

4. The apparatus of claim 1, wherein the one or more processors are further configured to:
determine a feedback cancellation signal to reduce linear components of the feedback component of the input audio signal; and
combine the feedback cancellation signal with the input audio signal prior to determining the output audio signal by applying the machine learning model, and
wherein the apparatus further comprises:
an amplification circuit coupled to the one or more processors and configured to amplify the output audio signal to drive a transducer from the output audio signal,
wherein the machine learning model is configured to reduce the feedback component by reducing nonlinearities of the amplification circuit.

5. The apparatus of claim 4, wherein the apparatus further comprises:
an additional amplification circuit coupled to the one or more processors and configured to amplify the input audio signal after combining the feedback cancellation signal with the input audio signal and before reducing the feedback component by applying the machine learning model, and
wherein the machine learning model is configured to reduce the feedback component by reducing nonlinearities of the additional amplification circuit.

6. The apparatus of claim 4, wherein the machine learning model is configured to reduce the feedback component based on parameters relating to the feedback cancellation signal.

7. The apparatus of claim 6, wherein the one or more processors comprise:
a digital signal processor configured to determine the feedback cancellation signal and to output the parameters relating to the feedback cancellation signal; and
a neural signal processor configured to execute the machine learning model based on the parameters relating to the feedback cancellation signal.

8. The apparatus of claim 4, wherein the machine learning model is configured to reduce the feedback component based on input parameters corresponding to input from a sensor uncorrelated with the feedback component.

9. The apparatus of claim 8, wherein the machine learning model is configured to reduce one or more artifacts resulting from the amplification circuit without reducing other howling in the input audio signal.

10. The apparatus of claim 9, wherein the one or more processors are configured to reduce the feedback component by applying the machine learning model comprises applying a time-domain filter to the input audio signal after the amplifying of the input audio signal, the time-domain filter configured based on the machine learning model.

11. The apparatus of claim 1, further comprising:
a first microphone coupled to the one or more processors, wherein the input audio signal is received from the first microphone; and
a transducer coupled to the one or more processors, wherein the transducer is configured to reproduce the output audio signal.

12. A method, comprising:
receiving an input audio signal, wherein the input audio signal includes a desired audio component and a feedback component; and
reducing the feedback component by applying a machine learning model to the input audio signal to determine an output audio signal.

13. The method of claim 12, wherein the machine learning model is configured to preserve a desired component.

14. The method of claim 12, further comprising:
amplifying the output audio signal for output to a transducer,
wherein reducing the feedback component comprises combining the input audio signal with a cancellation signal generated by the machine learning model to determine the output audio signal prior to amplifying the output audio signal, and
wherein the machine learning model is configured to generate the cancellation signal to cancel nonlinearities created by amplifying the output audio signal.

15. The method of claim 12, further comprising:
determining a feedback cancellation signal to reduce linear components of the feedback component of the input audio signal;
combining the feedback cancellation signal with the input audio signal prior to reducing the feedback component by applying the machine learning model; and
amplifying the output audio signal to drive a transducer from the output audio signal,
wherein the machine learning model is configured to reduce the feedback component by reducing nonlinearities of amplifying the output audio signal.

16. The method of claim 15, wherein the method further comprises:
amplifying the input audio signal after combining the feedback cancellation signal with the input audio signal and before reducing the feedback component by applying the machine learning model,
wherein the machine learning model is configured to reduce the feedback component by reducing nonlinearities of amplifying the input audio signal.

17. The method of claim 15, wherein the machine learning model is configured to reduce the feedback component based on input parameters relating to the feedback cancellation signal.

18. The method of claim 15, wherein the machine learning model is configured to reduce the feedback component based on input parameters corresponding to input from a sensor uncorrelated with the feedback component.

19. The method of claim 18, wherein:
the amplifying results in one or more artifacts resulting from the feedback component in the input audio signal, the one or more artifacts comprising howling, and
the machine learning model is configured to reduce the one or more artifacts resulting from the amplifying without reducing other howling in the input audio signal.

20. The method of claim 12, further comprising:
amplifying the input audio signal, wherein the amplifying results in one or more artifacts resulting from the feedback component in the input audio signal, and
wherein the machine learning model is configured to reduce the one or more artifacts.
